(19) United States
(12) Patent Application Publication
(10) Pub. No.: US 2019/0214004 A1
(43) Pub. Date: Jul. 11, 2019

(54) SPEECH OUTPUT DEVICE, SPEECH OUTPUT METHOD, AND SPEECH OUTPUT PROGRAM STORAGE MEDIUM

(71) Applicant: Toyota Jidosha Kabushiki Kaisha, Toyota-shi Aichi-ken (JP)

(72) Inventors: Hideki Kobayashi, Miyoshi-shi Aichi-ken (JP); Akihiro Muguruma, Nagoya-shi Aichi-ken (JP); Yukiya Sugiyama, Toyota-shi Aichi-ken (JP); Shota Higashihara, Chiryu-shi Aichi-ken (JP); Riho Matsuo, Nagoya-shi Aichi-ken (JP); Naoki Yamamuro, Nagoya-shi Aichi-ken (JP)

(21) Appl. No.: 16/238,104

(22) Filed: Jan. 2, 2019

(30) Foreign Application Priority Data
Jan. 10, 2018 (JP) 2018-002241

(51) Int. Cl. G10L 15/22; G10L 15/28

(52) U.S. Cl. CPC G10L 15/22; G10L 2015/221; G10L 15/28

(57) ABSTRACT

A speech output device includes: an acquisition section configured to acquire information held by an appliance regarding contents inside the appliance; and an output section configured to output speech according to the information acquired by the acquisition section from a speech output section.

### CROSS-REFERENCE TO RELATED APPLICATION

This application is based on and claims priority under 35 USC 119 from Japanese Patent Application No. 2018-002241 filed on Jan. 10, 2018, the disclosure of which is incorporated by reference herein.

### BACKGROUND

### Technical Field

The present disclosure relates to a speech output device, a speech output method, and a speech output program storage medium.

### Related Art

Japanese Patent Application Laid-Open (JP-A) No. 2009-300537 discloses a speech operated system including a terminal device and an onboard device that communicates with the terminal device. The speech operated system employs the terminal device and the onboard device, and causes the onboard device to be operated based on speech. In this speech operated system, the terminal device recognizes speech and transmits the recognition result to the onboard device. The onboard device controls its own operation based on the recognition result transmitted by the terminal device.

JP-A No. 2010-257183 discloses refrigerator including a reader device that reads a barcode recorded with product information such as the name of a purchased product, and a storage device that stores the product information read by the reader device.

In the technology described in JP-A No. 2009-300537, when a user speaks to the terminal device, operation of the onboard device is controlled according to this speech. There is room for improvement regarding increasing the convenience for the user. In the technology described in JP-A No. 2010-257183, no consideration is made to increasing convenience for the user by the manner in which a user is presented with the product information stored in the storage device provided to the refrigerator.

### SUMMARY

In consideration of the above circumstances, the present disclosure provides a speech output device, a speech output method, and a speech output program storage medium capable of increasing convenience for a user.

A first aspect of the present disclosure is a speech output device including an acquisition section configured to acquire information held by an appliance regarding contents inside the appliance, and an output section configured to output speech according to the information acquired by the acquisition section from a speech output section.

In the first aspect, the information regarding the contents held inside the appliance is acquired, and speech according to the acquired information is output from the speech output section. This enables a user to ascertain the information regarding the contents inside the appliance, and as a result enables the convenience for the user to be increased.

The first aspect may be configured such that the speech output section is installed inside a vehicle, the speech output device further includes a determination section configured to determine whether or not a user has boarded the vehicle, and the output section is configured to output the speech from the speech output section in cases in which the determination section has determined that the user has boarded the vehicle.

In the above configuration, speech according to the acquired information is output from the speech output section in cases in which the user is determined to have boarded the vehicle. This enables the user to ascertain information regarding the contents inside the appliance without performing any particular operation, and as a result enables convenience for the user to be more effectively increased.

A second aspect of the present disclosure is a speech output method executed by processing of a computer, the method including: acquiring information held by an appliance regarding contents inside the appliance; and outputting, by a speech output section, speech according to the acquired information.

The second aspect enables convenience for the user to be increased, similarly to in the first aspect.

A third aspect of the present disclosure is a non-transitory storage medium that stores a program causing a computer to execute speech output processing, the speech output processing including: acquiring information held by an appliance regarding contents inside the appliance; and outputting, by a speech output section, speech according to the acquired information.

The third aspect enables increased convenience for the user, similarly to in the first and second aspects.

The present disclosure obtains the advantageous effect of enabling increased convenience for the user.

### BRIEF DESCRIPTION OF THE DRAWINGS

FIG. 1 is a block diagram illustrating an example of a configuration of a speech output system according to an exemplary embodiment;

FIG. 2 is a diagram illustrating an example of contents information according to the exemplary embodiment;

FIG. 3 is a block diagram illustrating an example of a hardware configuration of the speech output device according to the exemplary embodiment;

FIG. 4 is a block diagram illustrating an example of a functional configuration of the speech output device according to the exemplary embodiment;

FIG. 5 is a flowchart illustrating an example of speech output processing according to the exemplary embodiment; and

FIG. 6 is a diagram illustrating an example of an operation screen of a speech output device according to a modified example.

### DETAILED DESCRIPTION

Detailed explanation follows regarding an exemplary embodiment for implementing the present disclosure, with reference to the drawings.

First, explanation follows regarding configuration of a speech output system 10 according to the exemplary embodiment, with reference to FIG. 1. As illustrated in FIG. 1, the speech output system 10 according to the exemplary embodiment includes a speech output device 12 and appliance 14. The speech output device 12 is installed in a vehicle. The appliance 14 is installed indoors, for example, in the house of a user of the speech output device 12, and holds contents information 16. The speech output device 12 is carried onto the vehicle by the user, for example. The speech output device 12 and the appliance 14 are connected to a network N so as to be capable of communicating with each other.

Note that in the exemplary embodiment, a case is explained in which an artificial intelligence (AI) speaker is applied as the speech output device 12. Moreover, in the exemplary embodiment, a case is explained in which a refrigerator equipped with a controller including a processor, a storage section, and so on (referred to as a smart refrigerator) is applied as the appliance 14.

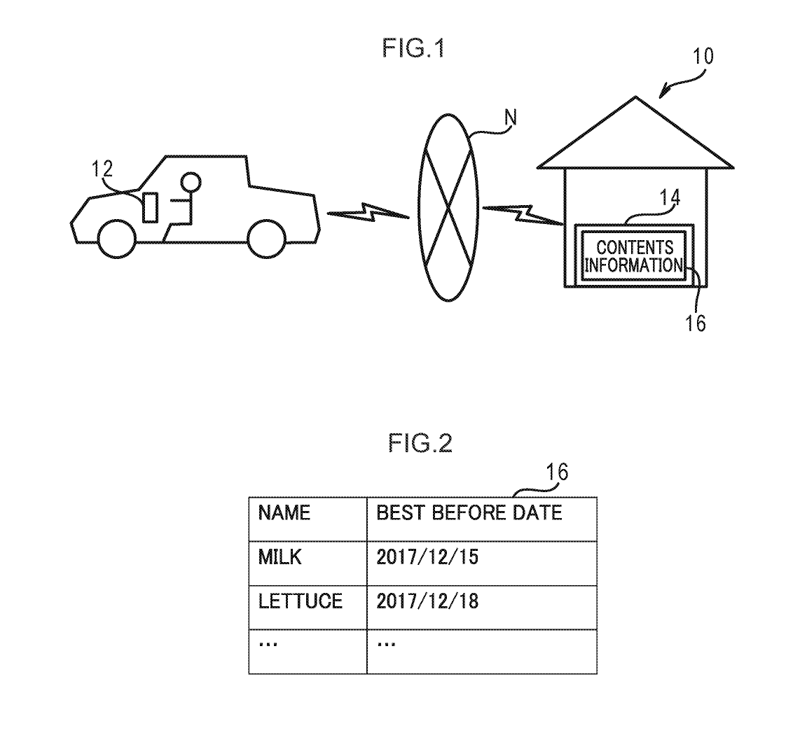

The contents information 16 is stored in the storage section provided in the appliance 14. The contents information 16 includes information regarding contents held inside the appliance 14. FIG. 2 illustrates an example of the contents information 16. As illustrated in FIG. 2, the contents information 16 according to the present exemplary embodiment includes the name of each of the contents, and the best before date of each of the contents, associated with the respective name of each of the contents.

For example, the names and best before dates of the contents may be recorded as the contents information 16 by the appliance 14 analyzing images captured by an inbuilt imaging device. Alternatively, the names and best before dates of the contents may be recorded as the contents information 16 by a barcode, integrated circuit (IC) tag, or the like appended to each of the contents being read using a reader device. Alternatively, the names and best before dates of the contents may be recorded as the contents information 16 by, for example, being input by a user using an input device such as a touch panel display included in the appliance 14.

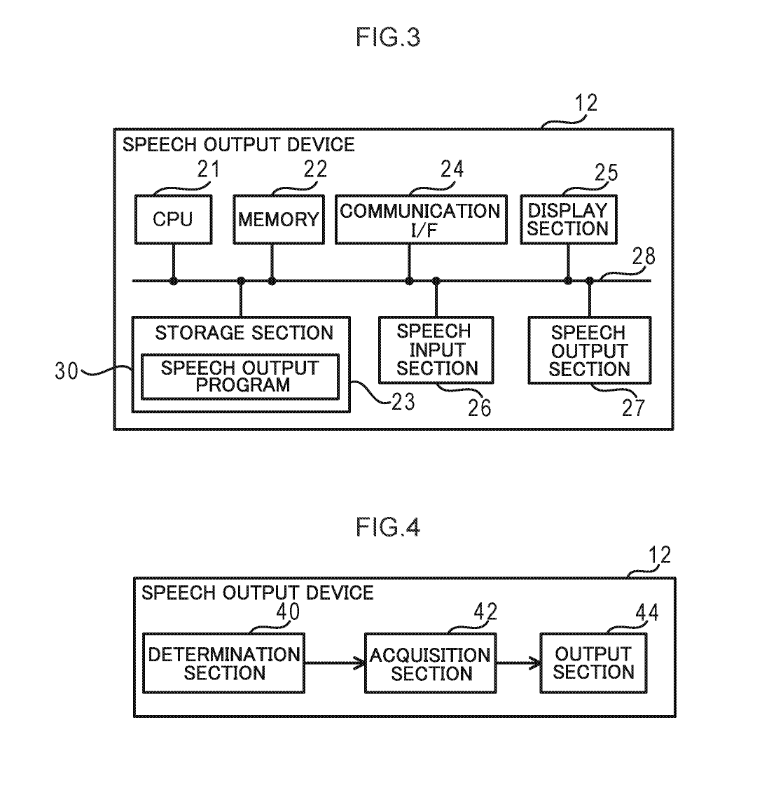

Explanation follows regarding a hardware configuration of the speech output device 12, with reference to FIG. 3. As illustrated in FIG. 3, the speech output device 12 includes a central processing unit (CPU) 21, memory 22 serving as a temporary storage region, and a non-volatile storage section 23. The speech output device 12 also includes a communication interface (I/F) 24 employed when communicating with external devices, a display section 25 such as a liquid crystal display, a speech input section 26 such as a microphone, and a speech output section 27 such as a speaker that outputs information in the form of speech into a vehicle cabin. The CPU 21, the memory 22, the storage section 23, the communication I/F 24, the display section 25, the speech input section 26, and the speech output section 27 are connected together through a bus 28. A speech output program 30 is stored in the storage section 23.

Explanation follows regarding functional configuration of the speech output device 12 according to the exemplary embodiment, with reference to FIG. 4. As illustrated in FIG. 4, the speech output device 12 includes a determination section 40, an acquisition section 42, and an output section 44. The CPU 21 of the speech output device 12 functions as the determination section 40, the acquisition section 42, and the output section 44 illustrated in FIG. 4 by executing the speech output program 30 stored in the storage section 23.

The determination section 40 determines whether or not a user has boarded the vehicle. In the exemplary embodiment, the determination section 40 determines that the user has boarded the vehicle in cases in which a short range wireless communication connection has been established between the speech output device 12 and a portable terminal in the possession of the user, such as a smartphone.

For example, the determination section 40 may determine that the user has boarded the vehicle in cases in which the user is detected as being seated in the driver's seat. In such cases, for example, the determination section 40 may acquire an output signal of a seating sensor for detecting that the user is seated in the driver's seat via an onboard electronic control unit (ECU), and detect that the user is seated in the driver's seat using the output signal acquired from the seating sensor.

Alternatively, for example, the determination section 40 may determine whether or not the user has boarded the vehicle by analyzing an image of inside the vehicle cabin obtained by capturing images using an onboard camera.

In cases in which the determination section 40 has determined that the user has boarded the vehicle, the acquisition section 42 acquires the contents information 16 from the appliance 14 via the network N.

The output section 44 emits speech by outputting speech from the speech output section 27 according to the contents information 16 acquired by the acquisition section 42. In the exemplary embodiment, the output section 44 extracts from the contents information 16 the names of any content with a best before date that expires within a predetermined duration (such as three days). The output section 44 outputs speech from the speech output section 27 including any extracted names of the contents and durations until the best before date expires. Namely, speech such as “The best before dates of food A and drink B expire in three days” is output from the speech output device 12. Note that the output section 44 may output speech including the names of any content whose best before date has already expired from the speech output section 27.

Alternatively, for example, instead of acquiring the contents information 16 from the appliance 14, the acquisition section 42 may transmit an acquisition instruction to the appliance 14 to acquire information regarding the contents of the appliance 14. In such cases, the appliance 14 extracts from the contents information 16 the names of any content with a best before date that expires within a predetermined duration. The appliance 14 then transmits information to the speech output device 12 including the names of any extracted content and the durations until the best before date expires. As a result, the acquisition section 42 acquires the information transmitted by the appliance 14, including any of the names of contents and durations until the best before date expires. The output section 44 then outputs speech from the speech output section 27 containing the respective names of contents and durations until the best before date expires, as acquired by the acquisition section 42.

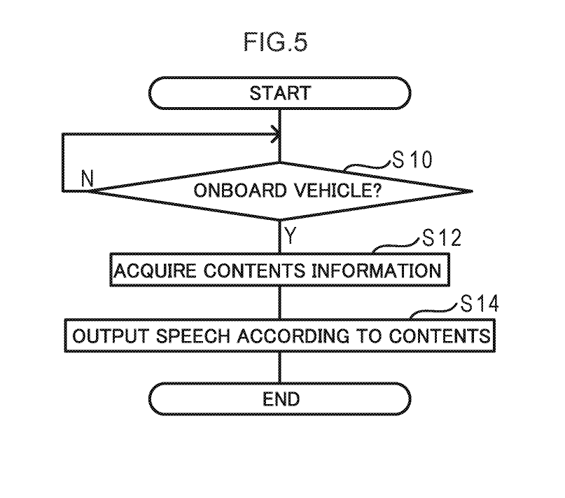

Next, explanation follows regarding operation of the speech output device 12 according to the exemplary embodiment, with reference to FIG. 5. FIG. 5 is a flowchart illustrating an example of a flow of speech output processing executed by the CPU 21 of the speech output device 12 according to the exemplary embodiment. In the exemplary embodiment, the speech output processing illustrated in FIG. 5 is executed by the CPU 21 executing the speech output program 30 pre-stored in the storage section 23. The speech output processing illustrated in FIG. 5 is executed in cases in which a power switch of the speech output device 12 is set to an ON state, for example.

At step S10 in FIG. 5, the determination section 40 determines whether or not the user has boarded the vehicle. The processing of step S10 is repeatedly executed until determination is affirmative. In cases in which determination is affirmative, processing transitions to step S12.

At step S12, the acquisition section 42 acquires the contents information 16 from the appliance 14 through the network N.

At step S14, as described above, the output section 44 outputs speech from the speech output section 27 according to the contents information 16 acquired by the processing of step S12. After the processing of step S14 ends, the speech output processing ends.

As explained above, in the exemplary embodiment, information being held by the appliance 14 regarding contents inside the appliance 14 is acquired, and the speech according to the acquired information is output is output from the speech output section 27. This enables a user to ascertain information regarding the contents inside the appliance 14 without looking inside the appliance 14, and as a result enables the convenience for the user to be increased.

Note that in the exemplary embodiment, a case has been explained in which the best before dates of the contents are included in the contents information 16; however, there is no limitation thereto. For example, a configuration may be adopted in which the dates of purchase of the contents are included in the contents information 16. In this case, for example, the output section 44 may extract from the contents information 16 the names of any content for which a predetermined duration or longer has elapsed since the date of purchase. In such a configuration, the speech output from the speech output section 27 includes the respective extracted names of contents and durations elapsed since the date of purchase.

In the above exemplary embodiment, a case has been explained in which speech according to information regarding the contents of the appliance 14 is output in cases in which it is determined that the user has boarded the vehicle; however, there is no limitation thereto. For example, a configuration may be adopted in which speech according to information regarding the contents of the appliance 14 is output when an ignition switch of the vehicle is set to an ON state. Alternatively, for example, a configuration may be adopted in which speech according to information regarding the contents of the appliance 14 is output in cases in which speech instructing the acquisition of information corresponding to the contents inside the appliance 14 has been input by the user through the speech input section 26.

In the above exemplary embodiment, an case has been explained in which a refrigerator is applied as the appliance 14; however, there is no limitation thereto. Another appliance capable of holding information regarding contents inside the appliance 14 may be applied as the appliance 14. For example, in cases in which a light fitting is applied as the appliance 14, an example configuration is one in which the speech output device 12 outputs speech from the speech output section 27 including the duration elapsed since a date of purchase of a light emitting unit such as a lightbulb or a fluorescent tube, this being the contents of the light fitting.

In the above exemplary embodiment, a case has been explained in which the contents information 16 is acquired from a single appliance 14; however, there is no limitation thereto. For example, a configuration may be adopted in which respective contents information 16 are acquired from plural appliances 14 of the same type as each other, or a configuration may be adopted in which respective contents information 16 are acquired from plural appliances 14 of different types to each other.

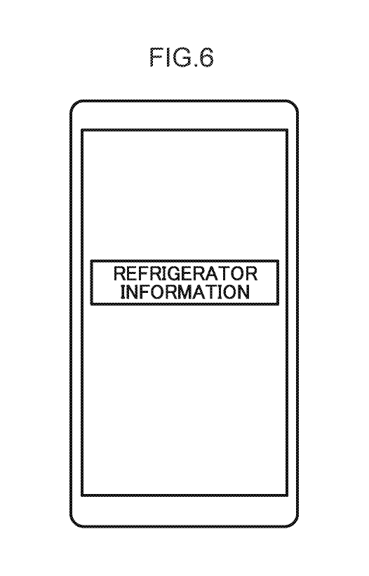

In the exemplary embodiment a case has been explained in which an AI speaker is applied as the speech output device 12; however, there is no limitation thereto. For example, a portable terminal such as a smartphone may be applied as the speech output device 12. In such cases, as illustrated in the example in FIG. 6, an example configuration is one in which the smartphone acquires information regarding contents inside the appliance 14 and outputs speech according to the acquired information from a speech output section in cases in which a user has tapped a button (the “refrigerator information” button in the example in FIG. 6) being displayed on a display section of the smartphone.

In the above exemplary embodiment, the speech output device 12 may derive a name of a recipe that uses any content whose best before date expires within a predetermined duration, and output speech from the speech output section 27 including the names of any missing ingredients required to make the derived recipe. In such cases, for example, the speech output device 12 may input any content whose best before date expires within a predetermined duration into a trained model, obtained by machine learning using ingredient names as input and recipe names as output, and then acquire a recipe name output from the trained model. The speech output device 12 may then output from the speech output section 27 speech including the name of missing ingredients required to make the acquired recipe.

The processing performed by the CPU 21 in the above exemplary embodiment has been described as being software processing performed by executing a program; however, the processing may be performed by hardware. Alternatively, the processing performed by the CPU 21 may be a combination of both software and hardware processing. The speech output program 30 stored in the storage section 23 may be stored on various types of storage medium and distributed thereon.

The present disclosure is not limited to the above exemplary embodiments, and, other than the above exemplary embodiments, obviously various other modifications may be implemented within a range not departing from the scope of the present disclosure.

What is claimed is:

1. A speech output device comprising a memory and a processor coupled to the memory, the processor configured to:
acquire information held by an appliance regarding contents inside the appliance; and
output speech according to the information acquired by the acquisition section from a speech output section.

2. The speech output device of claim 1, wherein:
the speech output section is installed inside a vehicle,
the processor is further configured to
determine whether or not a user has boarded the vehicle, and
output the speech from the speech output section in cases in which the determination section has determined that the user has boarded the vehicle.

3. A speech output method comprising:
acquiring information held by an appliance regarding contents inside the appliance; and
outputting, by a speech output section, speech according to the acquired information.

4. A non-transitory storage medium that stores a program causing a computer to execute speech output processing, the speech output processing comprising;
acquiring information held by an appliance regarding contents inside the appliance; and
outputting, by a speech output section, speech according to the acquired information.
